(19) United States
(12) Patent Application Publication
(10) Pub. No.: US 2009/0217789 A1
(43) Pub. Date: Sep. 3, 2009

(54) Ratchet control structure

(76) Inventor: Pi-Hsia Chang, Taichung County (TW)

Correspondence Address: CHANG, PI-HSIA, P.O. Box 44-2049, Taipei, 10668, TW

(21) Appl. No.: 12/073,180

(22) Filed: Mar. 3, 2008

(51) Int. Cl. B25B 13/46; B25B 13/06

(52) U.S. Cl. 81/60; 81/121.1

(57) ABSTRACT

A ratchet control structure includes a socket having a polygonal slot and inner ratchet teeth, a twisting head being an upper semi-circular body inserted into and combined with the socket, and a control ring fit with the twisting head and restricted by a bottom portion of the socket. The semi-circular body is for positioning two engagement blocks and has an elastic circular ball. An actuator is disposed below the twisting head. An inner wall of the control ring has two projecting push blocks facing the engagement blocks, and three arced slots for engaging with the circular ball so that the control ring can be positioned at three positions.

### BACKGROUND OF THE INVENTION

(1) Field of the Invention

The invention relates to a hand tool, and more particularly to a multi-purpose ratchet control structure capable of controlling a rotating direction.

(2) Description of the Prior Art

A conventional ratchet is frequently controlled by an actuating rod for actuating two engagement blocks, which respectively or simultaneously engage with the ratchet to control and lock the ratchet so that a tool, such as a wrench, can drive an object. Alternatively, a rotating rod directly executes the elastic tripping rotation to engage the rotating rod with the ratchet unidirectionally so that the rotation control and the engagement of the ratchet can be achieved according to various drive control structures. However, no matter what kind of structure is adopted, the ratchet control device is mainly directly disposed on a wrench driving head, a driver or a driving rod. The design that one ratchet can control various applications is seldom seen, and one ratchet can only provide the single function.

Furthermore, the currently used engagement blocks are positioned at an inner wall ring of a wrench head due to the structural limitations, and cannot be disposed within the twisting head so the structure has the limited function.

### SUMMARY OF THE INVENTION

It is therefore an object of the invention to provide a ratchet control structure having a rotating ring for controlling three states. In addition, the ratchet control structure may be combined with a driver, a wrench or a driving rod to achieve the multi-purpose driving function.

Another object of the invention is to provide a ratchet control structure having engagement blocks disposed in a twisting head.

Therefore, the invention provides a ratchet control structure including a socket, a twisting head and a control ring.

The socket has an upper polygonal slot and a lower accommodating space formed with inner ratchet teeth. A through hole at a bottom portion of the polygonal slot communicates the polygonal slot with the accommodating space.

The twisting head has an upper semi-circular body inserted into the accommodating space of the socket. The semi-circular body has one side formed with two positioning slots and the other side formed with a positioning hole. Two engagement blocks may be respectively positioned into the positioning slots. An elastic member for pressing is disposed between the two engagement blocks. An outer side of the engagement block is an engagement end for engaging with the inner ratchet teeth. A spring and a circular ball are inserted into the positioning hole. An actuator is disposed below the twisting head, and a projecting ring is disposed between the actuator and the semi-circular body.

The control ring is fit with the projecting ring of the twisting head and restricted by and positioned at a bottom portion of the socket. An inner wall of the control ring has two projecting push blocks and three arced slots. The push blocks face the engagement block, and the arced slots are for engaging with the circular ball of the twisting head to position the control ring at three positions.

The control ring is rotated such that one of the push blocks pushes the corresponding engagement block to escape from the inner ratchet teeth. The other one of the push blocks pushes the corresponding engagement block to engage with the inner ratchet teeth so that three states may be obtained. A polygonal driving ring, the polygonal slot and the actuator are provided to match with various applications.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention.

FIG. 1 is a pictorially exploded view showing the invention.

FIG. 2 is a schematically cross-sectional view showing the invention.

FIG. 3 is a schematically cross-sectional view showing two engagement blocks engaging with inner ratchet teeth according to the invention.

FIG. 4 is a schematically cross-sectional view showing a circular ball sliding into a middle arced slot of a control ring according to the invention.

FIG. 5 is a schematically cross-sectional view showing an engagement block engaging with the inner ratchet teeth according to the invention.

FIG. 6 is a schematically cross-sectional view showing the circular ball sliding into an arced slot of the control ring according to the invention.

FIG. 7 is a pictorially exploded view showing a hand driving ring according to the invention.

FIG. 8 is a pictorial view showing the invention applied to a rotating wrench.

FIG. 9 is a pictorial view showing the invention applied to a 360-degree rotating wrench.

FIG. 10 is a pictorial view showing the invention applied to a conventional wrench.

FIG. 11 is a pictorial view showing the invention applied to a ratchet twist wrench.

FIG. 12 is a pictorial view showing the invention applied to a driver.

FIG. 13 is a pictorial view showing the invention applied to another driver.

FIG. 14 is a pictorial view showing the invention directly formed and fixed to a bottom end of the driver.

FIG. 15 is a pictorial view showing the invention applied to an L-shape rod.

FIG. 16 is a pictorial view showing the invention applied to a T-shaped rod.

FIG. 17 is a pictorial view showing the invention applied to a driving rod.

FIG. 18 is a pictorial view showing the invention applied to another rotating wrench.

### DETAILED DESCRIPTION OF THE PREFERRED EMBODIMENTS

The present invention will be apparent from the following detailed description, which proceeds with reference to the accompanying drawings, wherein the same references relate to the same elements.

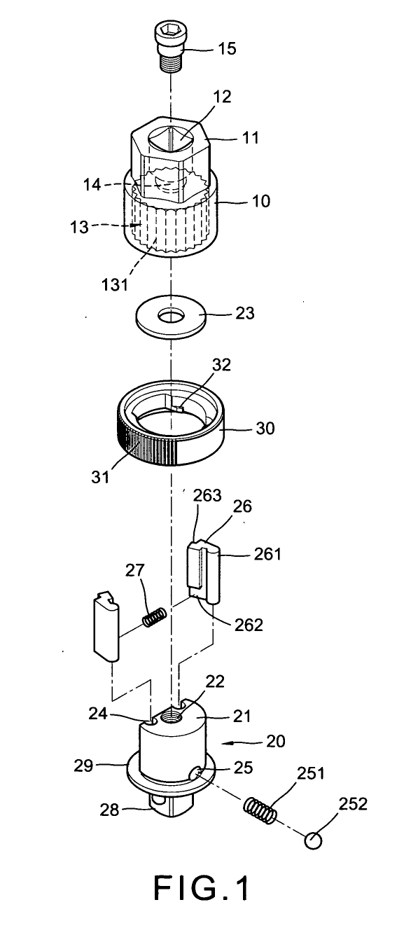

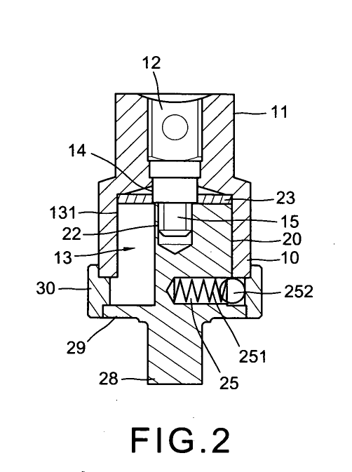

Referring to FIGS. 1 to 4, a ratchet control structure according to the invention includes a socket 10, a twisting head 20 and a control ring 30. A polygonal driving ring 11, which is a hexagonal driving ring and to be driven by a wrench or a sleeve, is disposed above the socket 10. The socket 10 is formed with an upper polygonal slot 12 and an accommodating space 13. The upper polygonal slot 12 is a quadrangular slot, into which a rectangular driving head may be inserted. The accommodating space 13 has an inner wall formed with inner ratchet teeth 131. A bottom portion of the polygonal slot 12 is formed with a through hole 14 for communicating the polygonal slot 12 with the accommodating space 13. A bolt 15 may be inserted into the through hole 14.

The twisting head 20 has an upper semi-circular body 21, which is about a three-fourth semi-circular body. The semi-circular body 21 is inserted into the accommodating space 13 of the socket 10. A top surface of the semi-circular body 21 is formed with a screw hole 22. A pad ring 23 may be placed on the top surface of the semi-circular body 21 so that the bolt 15 may be inserted into the through hole 14 of the socket 10 and screwed to the screw hole 22. One side of the semi-circular body 21 is a cut surface formed with two axial positioning slots 24. The other side of the semi-circular body 21 is a camber formed with a radial positioning hole 25. Two engagement blocks 26 may be respectively positioned into the two positioning slots 24. One end of the engagement block 26 is a projecting arced post 261, which engages with the positioning slot 24 of the semi-circular body 21. An elastic member (spring) 27 for pressing is disposed between the two engagement blocks 26. The engagement block 26 has a lower concave restricting slot 262 for preventing the elastic member 27 from escaping. An outer side of the engagement block 26 is a ladder-like engagement end 263 for engaging with the inner ratchet teeth 131. A spring 251 and a circular ball 252 are inserted into the positioning hole 25. An actuator 28 is disposed below the twisting head 20. The actuator 28 is a quadrangular head to be inserted into a sleeve for driving the sleeve. A projecting ring 29 is disposed between the actuator 28 and the semi-circular body 21.

An outer wall surface of the control ring 30 has anti-skid textures 31 or several projections. The control ring 30 is fit with the twisting head 20, disposed above the projecting ring 29, and restricted by and positioned at the bottom portion of the socket 10. An inner wall of the control ring 30 has two projecting push blocks 32 and three arced slots 33, 34 and 35, as shown in FIG. 4. The push blocks 32 face the engagement block 26. The arced slots 33, 34 and 35 are for engaging with the elastic circular ball 252 of the twisting head 20 to position the control ring 30 at three positions.

According to the above-mentioned ratchet control structure of the invention, the polygonal driving ring 11 of the socket 10 is to be driven by the wrench or the sleeve, the polygonal slot 12 of the socket 10 is for fitting with the rectangular driving head, and the actuator 28 of the twisting head 20 is to be driven by the sleeve according to the requirements to be described in the following.

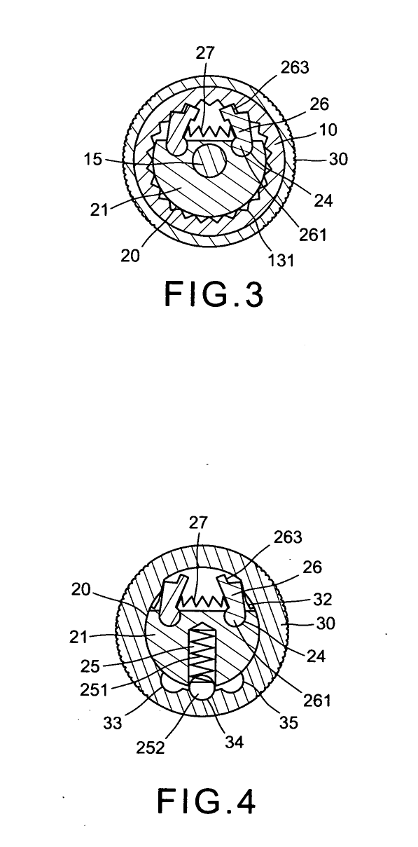

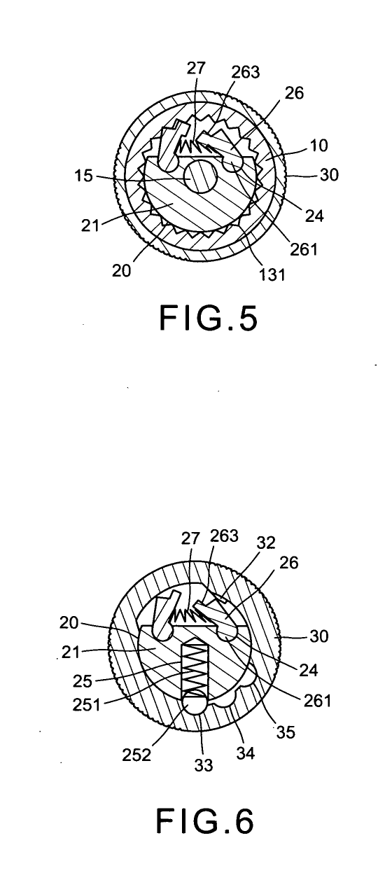

In operation, the control ring 30 is firstly rotated. When the circular ball 252 of the twisting head 20 is engaged with one arced slot 33 of the control ring 30 (see FIGS. 5 and 6), the right-side push block 32 pushes the corresponding engagement block 26 to escape from the inner ratchet teeth 131, and the left-side push block 32 pushes the corresponding engagement block 26 to engage with the inner ratchet teeth 131 so that the driving operation in one direction may be performed. Oppositely, the driving operation in the other direction may be performed. When the control ring 30 is rotated, the circular ball 252 of the twisting head 20 engages with the middle arced slot 34 of the control ring 30 (see FIGS. 3 and 4), and the two engagement blocks 26 engage with the inner ratchet teeth 131 so that three states, including a clockwise driving state, a counterclockwise driving state and a stationary state, can be obtained.

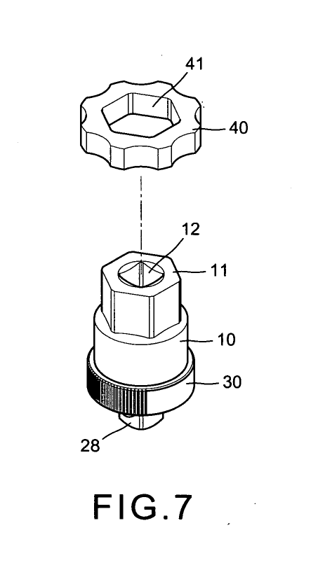

As shown in FIG. 7, a hand driving ring 40 is fit with the polygonal driving ring 11 of the socket 10, and an inner wall of the hand driving ring 40 is a polygonal inner wall 41 fit with the polygonal driving ring 11 so that a palm of a hand can drive the socket 10.

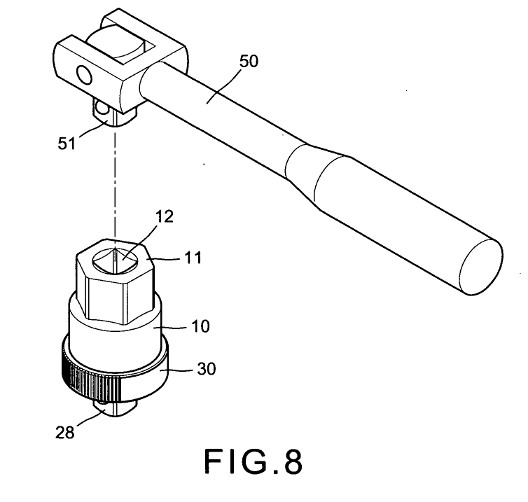

As shown in FIG. 8, the invention is applied to a rotating wrench 50, which has a rectangular block 51 inserted into the polygonal slot 12 so that the ratchet control structure can be combined with the rotating wrench 50 to provide the driving function.

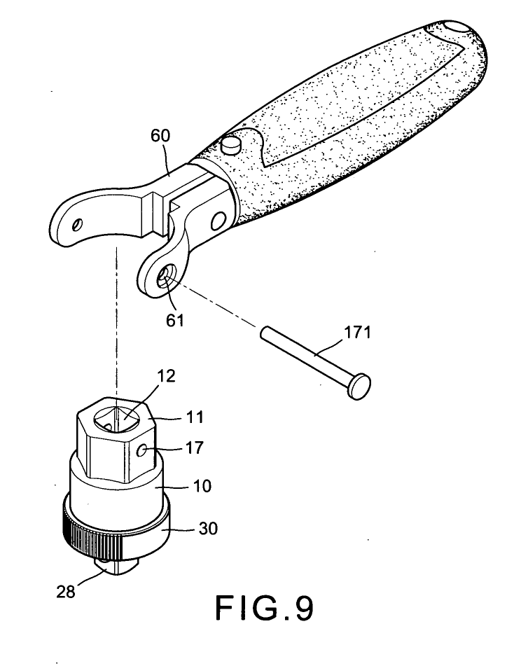

As shown in FIG. 9, the invention is applied to a retractable rotating wrench 60, which may be directly pivotally connected to a pivotal hole 61 of the rotating wrench 60. The polygonal driving ring 11 is formed with a hole 17, wherein a rivet 171 or a bolt is provided to combine the ratchet control structure with the rotating wrench 60 to provide the driving function.

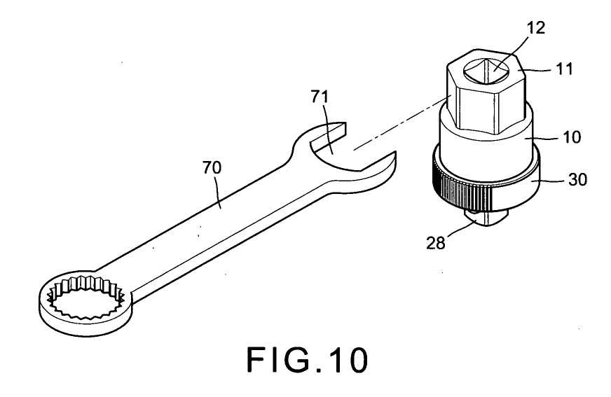

As shown in FIG. 10, the invention is applied to a conventional dual-head wrench 70 having a jaw 71 directly fit with the polygonal driving ring 11 of the socket 10. So, the ratchet control structure can be combined with the conventional wrench 70 to provide the driving function.

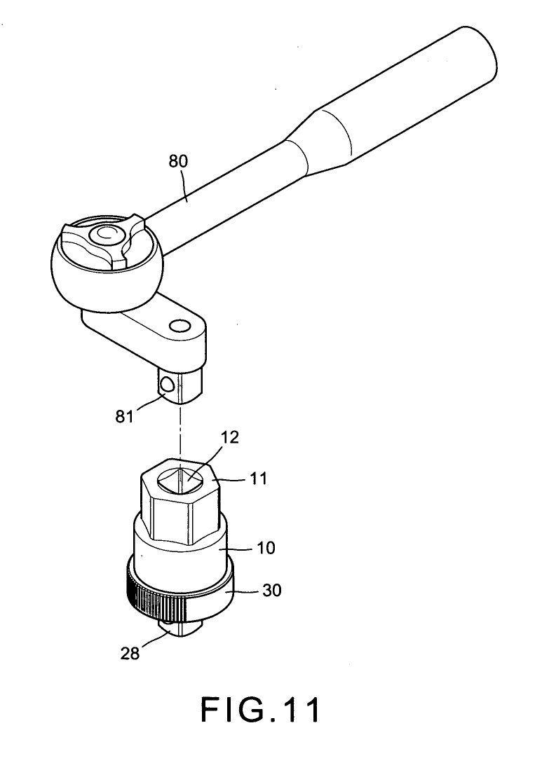

As shown in FIG. 11, the invention is applied to a ratchet twist wrench 80, which has a twist rectangular block 81 inserted into the polygonal slot 12. So, the ratchet control structure can be combined with the rotating wrench 80 to provide the driving function.

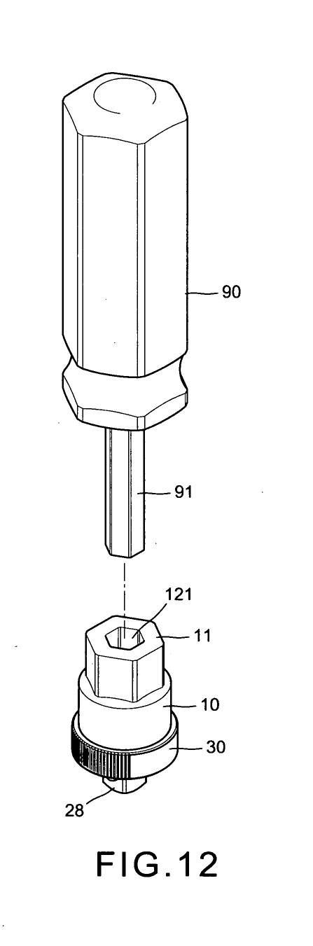

As shown in FIG. 12, the invention is applied to a driver 90 having a polygonal rod body 91 inserted into the polygonal slot 121 of this invention, which is a hexagonal slot. So, the ratchet control structure can be combined with the driver 90 to provide the driving function.

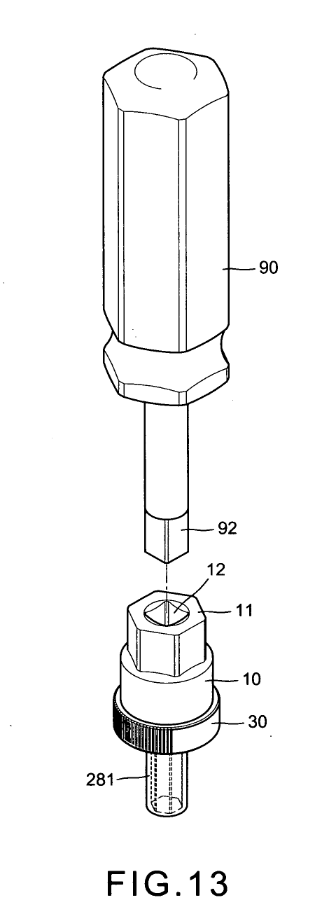

As shown in FIGS. 13, the actuator 281 is replaced with a sleeve and then applied to the driver 90. The driver 90 has a rod body 92 inserted into the polygonal slot 12 of this invention. So, the ratchet control structure can be combined with the driver 90 to drive an object through the actuator (sleeve) 281.

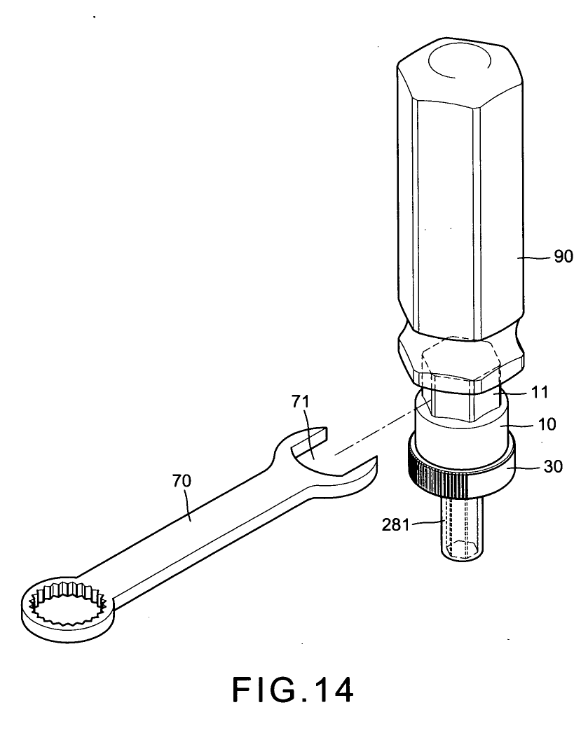

As shown in FIG. 14, the rod body 92 (see FIG. 13) of the driver 90 is directly fixed in the polygonal slot 12 of this invention, wherein the rod body 92 may be directly fixed into the polygonal slot 12 or may be covered when the handle of the driver 90 is being molded. Thus, the hand can hold the driver 90 to drive the object. If the grip strength of the hand is insufficient, the jaw 71 of the wrench 70 can be directly fit with the polygonal driving ring 11 of the socket 10 to assist in driving the object.

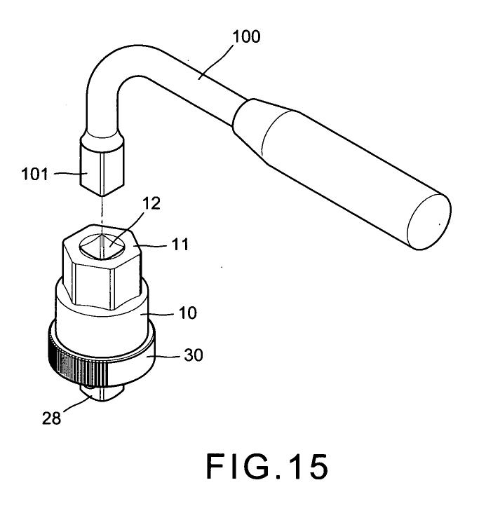

As shown in FIG. 15, the invention is applied to an L-shape rod 100 having a rectangular block 101 inserted into the polygonal slot 12 of this invention. So, the ratchet control structure can be combined with the L-shape rod 100 to provide the driving function.

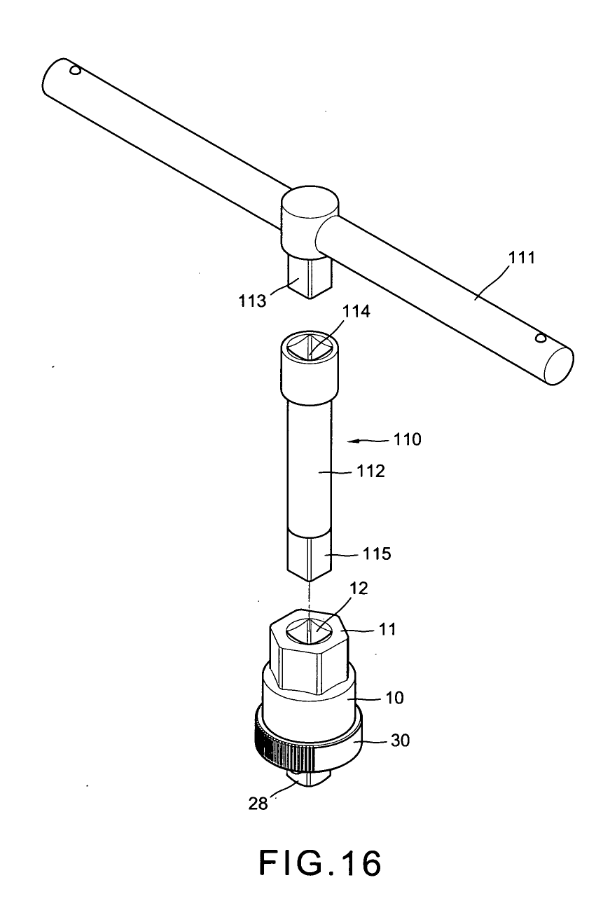

As shown in FIG. 16, the invention is applied to a T-shaped rod 110, which has a horizontal rod 111 and a vertical rod 112 combined together. The horizontal rod 111 has a rectangular block 113 inserted into a sleeve 114 of the vertical rod 112. A bottom end of the vertical rod 112 has a rectangular block 115 inserted into the polygonal slot 12 of this invention. So, the ratchet control structure can be combined with the T-shaped rod 110 to provide the driving function.

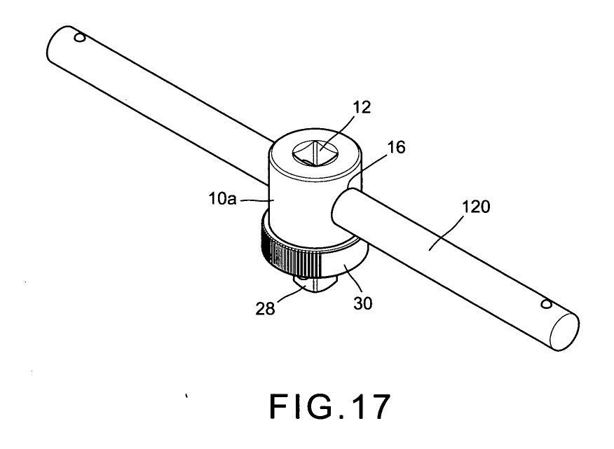

As shown in FIG. 17, an upper half portion of the socket 10a is formed with a radial hole 16, into which a driving rod 120 can be inserted. So, the ratchet control structure can be combined with the driving rod 120 to provide the driving function.

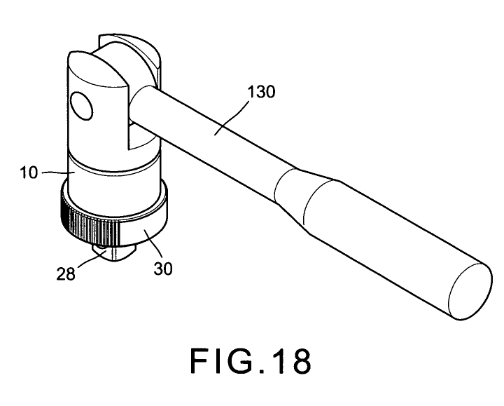

As shown in FIG. 18, the invention is applied to another rotating wrench 130. The rotating wrench 130 has a hexagonal slot (not shown) fit with the polygonal driving ring. So, the ratchet control structure can be combined with the rotating wrench 130 to drive the object.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A ratchet control structure, comprising:
a socket having an upper polygonal slot and a lower accommodating space formed with inner ratchet teeth, wherein a through hole at a bottom portion of the polygonal slot communicates the polygonal slot with the accommodating space;
a twisting head having an upper semi-circular body inserted into the accommodating space of the socket, wherein the semi-circular body has one side formed with two positioning slots and the other side formed with a positioning hole, two engagement blocks may be respectively positioned into the positioning slots, an elastic member for pressing is disposed between the two engagement blocks, an outer side of the engagement block is an engagement end for engaging with the inner ratchet teeth, a spring and a circular ball are inserted into the positioning hole, an actuator is disposed below the twisting head, and a projecting ring is disposed between the actuator and the semi-circular body; and
a control ring fit with the projecting ring of the twisting head and restricted by and positioned at a bottom portion of the socket, wherein an inner wall of the control ring has two projecting push blocks and three arced slots, the push blocks face the engagement block, and the arced slots are for engaging with the circular ball of the twisting head to position the control ring at three positions,
wherein the control ring is rotated such that one of the push blocks pushes the corresponding engagement block to escape from the inner ratchet teeth, and the other one of the push blocks pushes the corresponding engagement block to engage with the inner ratchet teeth so that three states may be obtained, and a polygonal driving ring, the polygonal slot and the actuator are provided to match with various applications.

2. The ratchet control structure according to claim 1, wherein a top surface of the semi-circular body of the twisting head is formed with a screw hole, a pad ring is disposed on the top surface of the semi-circular body, and a bolt is inserted into the through hole of the socket and screwed to the screw hole.

3. The ratchet control structure according to claim 1, wherein one end of the engagement block is a projecting arced post, which engages with the positioning slots of the semi-circular body, and the engagement block is formed with a lower concave restricting slot for preventing the elastic member from escaping.

4. The ratchet control structure according to claim 1, wherein an outer wall of the control ring is formed with anti-skid textures.

5. The ratchet control structure according to claim 1, wherein the polygonal slot of the socket is a quadrangular slot.

6. The ratchet control structure according to claim 1, wherein the actuator of the twisting head is a quadrangular head.

7. The ratchet control structure according to claim 1, wherein an upper half portion of the socket is formed with a radial hole to be inserted by a driving rod.

8. The ratchet control structure according to claim 1, wherein the polygonal driving ring of the socket is to be fit with a hand driving ring, and an inner wall of the hand driving ring is a polygonal inner wall.

9. The ratchet control structure according to claim 1, wherein the actuator of the twisting head is a sleeve.
